(19) United States
(12) Patent Application Publication
(10) Pub. No.: US 2024/0419945 A1
(43) Pub. Date: Dec. 19, 2024

(54) SPEECH PROCESSING USING MACHINE LEARNING FOR CONVERSATIONAL AI SYSTEMS AND APPLICATIONS

(71) Applicant: NVIDIA Corporation, Santa Clara, CA (US)

(72) Inventors: Xianchao Wu, Tokyo (JP); Peiying Ruan, Kanazawa (JP); Yi Dong, Lexington, MA (US)

(21) Appl. No.: 18/334,752

(22) Filed: Jun. 14, 2023

(51) Int. Cl. G06N 3/0455; G10L 15/18

(52) U.S. Cl. CPC G06N 3/0455; G10L 15/1815

(57) ABSTRACT

In various examples, techniques for accelerating inference in text and speech processing for conversational AI systems and applications is described herein. Systems and methods are disclosed that use one or more techniques, such as token merging, in order to reduce a number of tokens processed by one or more machine learning models. For instance, the machine learning model(s) may process text and, based at least on the processing, generate scores (e.g., attention scores) indicating relationships between tokens associated with the text. The machine learning model(s) may then use the scores to merge at least one pair of the tokens. As described herein, the merging may reduce the overall number of tokens associated with the text while still maintaining the same semantic meaning as the original text. Next, the machine learning model(s) may process the reduce number of tokens in order to determine an output associated with the text.

### BACKGROUND

Speech processing systems are used in many different applications, such as applications for transcribing speech, translating speech to a new language, requesting information (e.g., information about objects, items, features, etc.), scheduling travel plans (e.g., booking arrangements for transportation and accommodations etc.), planning activities (e.g., making reservations, etc.), communicating with others (e.g., making phone calls, starting video conferences, etc.), shopping for items (e.g., purchasing items from online marketplaces, ordering food from a local restaurant, etc.), and/or so forth. Some speech processing systems operate by receiving speech—such as speech that corresponds to one or more letters, words, numbers, and/or symbols—that is generated using an input device. The speech processing system then processes the speech, such as by using automatic speech recognition (ASR), in order to interpret the speech. Based on interpreting the speech, the speech processing system may generate a response, such as the transcribed text related to the speech.

In some examples, speech processing systems may operate by generating tokens (e.g., vectors) that represent one or more words and/or one or more portions of the words associated with the speech. For example, if the speech includes the words “What is the score of the baseball game?,” then a speech processing system may generate a first token for a word “what”, a second token for a word “is”, a third token for a word “the”, a fourth token for a word “of”, a fifth token for a word “the”, a sixth token for a portion of a word “base”, a seventh token for a portion of a word “ball”, a ninth token for a word “game” and a tenth token for a symbol “?”. The speech processing system may then process the tokens in order to interpret the speech. As such, an inference speed associated with speech processing systems may depend on the number of tokens that the speech processing systems need to process. For example, the greater the number of tokens to process, the longer it may take to perform inference using a speech processing system. As such, reducing the number of tokens that speech processing systems process may also accelerate the inference of the speech processing systems.

Because of this, a few token pruning techniques have been developed in order to try and accelerate the inference associated with speech processing. For example, Squeezeformer incorporates a temporal U-Net structure to a Conformer, which also reduces a cost of multi-head self attention (MHSA) modules on long sequences. For instance, in the temporal U-Net structure, (1) a temporal reduction layer that uses a depthwise down-sampling layer to sub-sample the input signal and (2) a temporal recover layer that duplicates each token to recover the sequences length, performs a linear projection and skip connects with counterpart tensor before the temporal reduction. However, generally tuning the down-sampling rate for a given training dataset is not trivial and requires retraining the model from scratch, which may require a large amount of computing resources and/or time to perform.

Additionally, Efficient Conformer performs progressive down-sampling to the Conformer encoder's input sequence together with a grouped attention mechanism which first assigns tokens to a limited number of groups and then performs attention computing inside each group only. This group attention reduces the MHSA time complexity for a sequence length. However, similar to Squeezeformer, the down-sampling rate is language dependent and the tuning of it requires retraining the model from scratch. Again, this may require a large amount of computing resources and/or time to perform.

### SUMMARY

Embodiments of the present disclosure relate to techniques for accelerating inference in speech and text processing for conversational AI systems and applications. Systems and methods are disclosed that use one or more techniques, such as token merging, in order to reduce a number of tokens processed using one or more machine learning models. For instance, the machine learning model(s) may process text and, based at least on the processing, generate scores (e.g., attention scores) indicating relationships between tokens associated with the text. The machine learning model(s) may then use the scores to merge at least one pair of the tokens. As described herein, the merging may reduce the overall number of tokens associated with the text while still maintaining the same semantic meaning as the original text. Next, the machine learning model(s) may process the reduce number of tokens in order to determine an output associated with the text.

In contrast to conventional systems, such as those described above, the current systems, in some embodiments, are able to use one or more techniques described herein, such as token merging, to reduce the number of tokens that are processed by a machine learning model(s) that performs text (e.g., speech) processing. By reducing the number of tokens that are processed by the machine learning model(s), inference associated with the machine learning model(s) may be accelerated as compared to inference associated with conventional machine learning models that do not perform token merging when processing the same text. Additionally, by reducing the number of tokens that are processed by the machine learning model(s), the amount of computing resources used by the machine learning model(s) to process the text may be reduced as compared to the conventional machine learning models that do not perform token merging when processing the same text.

Furthermore, in contrast to the conventional systems that perform token pruning, such as Squeezeformer and Efficient Conformer, the current systems, in some embodiments, may not require further training of the machine learning model(s). Rather, and as described in more detail herein, one or more components (e.g., one or more modules) used for token merging may be added to one or more portions of the machine learning model(s) associated with the current systems, where the machine learning model(s) is still able to process text even with the added component(s). By eliminating the need to further train the machine learning model(s), the current system(s) may thus not require additional computing resources and/or time for retraining.

### BRIEF DESCRIPTION OF THE DRAWINGS

The present systems and methods for techniques for accelerating inference in text and speech processing for conversational AI systems and applications are described in detail below with reference to the attached drawing figures, wherein:

FIG. 1 is an example data flow diagram for a process of using token merging to accelerate inference in a machine learning model(s), in accordance with some embodiments of the present disclosure;

FIG. 2 illustrates an example of processing input data in order to generate tokens, in accordance with some embodiments of the present disclosure;

FIGS. 3A-3C illustrate an example of performing token merging associated with speech processing, in accordance with some embodiments of the present disclosure;

FIG. 4 illustrates an example of a Conformer architecture that includes token merging, where the Conformer architecture is associated with automatic speech recognition, in accordance with some embodiments of the present disclosure;

FIG. 5 illustrates an example of a speech recognition module that includes token merging, in accordance with some embodiments of the present disclosure;

FIG. 6 illustrates an example of a machine learning model that is associated with translating speech from a first language to a second language, in accordance with some embodiments of the present disclosure;

FIG. 7 is a flow diagram showing a method for performing token merging when processing text, in accordance with some embodiments of the present disclosure;

FIG. 8 is a flow diagram showing a method for merging tokens associated with text, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to techniques for accelerating inference in text and speech processing for conversational AI systems and applications. For instance, a system(s) may generate one or more machine learning models and/or alter one or more existing machine learning models such that the machine learning model(s) performs token merging when processing data. As described herein, the machine learning model(s) may be trained for speech processing, such as automatic speech recognition (ASR), natural language understanding (NLU), and/or so forth, included as part of a dialogue system, and/or used for one or more additional and/or alternative purposes. As such, the text processed by the machine learning model(s) may be represented by text data and/or may be associated with user speech represented by audio data. Additionally, the text may include one or more letters, words, numbers, symbols (e.g., characters), and/or the like.

For more detail, the machine learning model(s) may include one or more first components (e.g., one or more first layers, one or more first modules, etc.) that process the text (e.g., using tokenization) in order to generate tokens representing the text. As described herein, a token may represent a word, a part of a word, a symbol (e.g., punctuation), a character, a number, and/or the like associated with the text. For example, if the text includes “Who won the baseball game yesterday?” then the first component(s) may generate a first token that represents a word “who”, a second token that represents a word “won”, a third token that represents a word “the”, a fourth token that represents a part of a word “base”, a fifth token that represents a part of a word “ball”, a sixth token that represents a word “game”, a seventh token that represents a part of a word “yes”, an eighth token that represents a part of a word “ter”, and a ninth token that represents a part of a word “day”. In some examples, and as described in more detail herein, one or more of the tokens (e.g., each token) may be mapped to a respective vector.

The machine learning model(s) may include one or more second components (e.g., one or more second layers, one or more second modules, etc.) that process the tokens and, based at least on the processing, determine at least scores indicating relationships between the tokens. For example, the second component(s) may include an attention component that is configured to determine attention scores associated with pairs of the tokens. As described herein, an attention score may be determined using dot-product attention, local attention, convolutional attention, hierarchical attention, structured attention, multi-head attention, cross-modal attention, and/or any other type of attention technique. For example, and using the example above where the first component(s) generates the nine tokens, the second component(s) may generate a first score associated with a token pair that includes the first token and the second token, a second score associated with a token pair that includes the second token and the third token, a third score associated with a token pair that includes the third token and the fourth token, and/or so forth.

The machine learning model(s) may also include one or more third components (e.g., one or more third layers, one or more third modules, etc.) that perform token merging using at least the scores. For instance, in some examples, the third component(s) may determine to merge a token pair based on a score associated with the token pair satisfying (e.g., being equal to or greater than) a threshold score. As described herein, the threshold score may include, but is not limited to, 0.5, 0.9. 0.99, 5, 50, 100, 75%, 85%, 90%, 95%, 99%, 99.9%, and/or any other number and/or percentage. In some examples, the third component(s) may limit the number of token pairs that are merged, such as at one or more iterations (e.g., each layer of token merging) associated with the text. For example, even if scores associated with multiple token pairs satisfy the threshold score, the third component(s) may still limit the number of token pairs that are merged to a threshold number of pairs. As described herein, the threshold number of pairs may include, but is not limited to, one pair, two pairs, five pairs, ten pairs, and/or any other number of pairs. In some examples, the threshold number of pairs may be static while, in other examples, the threshold number of pairs may be dynamic based on one or more factors (e.g., the length of the text, the number of tokens, etc.).

In some examples, based on the 1D constraints associated with text, the third component(s) may use one or more additional and/or alternative techniques for merging tokens. For example, such as to maintain the ordering of the input sequence associated with the text, the third component(s) may only merge token pairs where tokens are located proximate to one another. For example, and again using the example above with the nine tokens, for the fifth token, the third component(s) may determine whether to merge a first token pair that includes the fourth token and the fifth token or a second token pair that includes the fifth token and the sixth token, but without considering any other token pairs associated with the fifth token.

Additionally, in some examples, such as to also maintain the ordering of the input sequence associated with the text, the third component(s) may use one or more techniques to recover the token order. For instance, since the third component(s) may merge tokens that are located next to one another within the sequence, the third component(s) may cause the newly generated tokens to remain in similar positions as the merged token pairs. For example, and again using the example above with the nine tokens, the third component(s) may perform one or more of the processes described herein to generate a tenth token by merging the fifth token with the sixth token. The third component(s) may then maintain the order associated with the text by placing the tenth component between the fourth token and the seventh token. As described herein, by maintaining the order associated with the tokens, the third component(s) may also maintain the same semantic meaning as the original text.

The machine learning model(s) may include one or more fourth component(s) (e.g., one or more fourth layers, one or more fourth modules, etc.) that are configured to process the tokens, after merging, in order to generate an output associated with the text. For a first example, such as if the machine learning model(s) is associated with speech recognition, the output may include text representing input speech. For a second example, such as if the machine learning model(s) is associated with speech-to-text translation, the output may include text associated with a first language that differs from a second, different language associated with input speech. Still, for a third example, such as if the machine learning model(s) is associated with a dialogue system, the output may include text representing a response to an input request. While these are just three example outputs associated with the machine learning model(s), in other examples, the machine learning model(s) may be trained to generate any type of output.

In some examples described herein, the machine learning model(s) is described as including components. A component may include, but is not limited to, one or more layers, one or more modules, and/or one or more other components associated with machine learning models. Additionally, a layer may include an input layer, a feature extraction layer, a convolutional layer, a rectified linear unit layer, an attention layer, a pooling layer, and add and norm layer, a feed forward layer, a fully connected layer, a deconvolutional layer, a SoftMax layer, and/or any other type of layer that may be used by machine learning models and/or neural networks.

The systems and methods described herein may be used for a variety of purposes, by way of example and without limitation, speech processing, dialogue management, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implementing large language models (LLMs), systems implemented at least partially in a data center, systems for performing conversational AI operations, systems for performing light transport simulation, systems for performing collaborative content creation for 3D assets, systems implemented at least partially using cloud computing resources, and/or other types of systems.

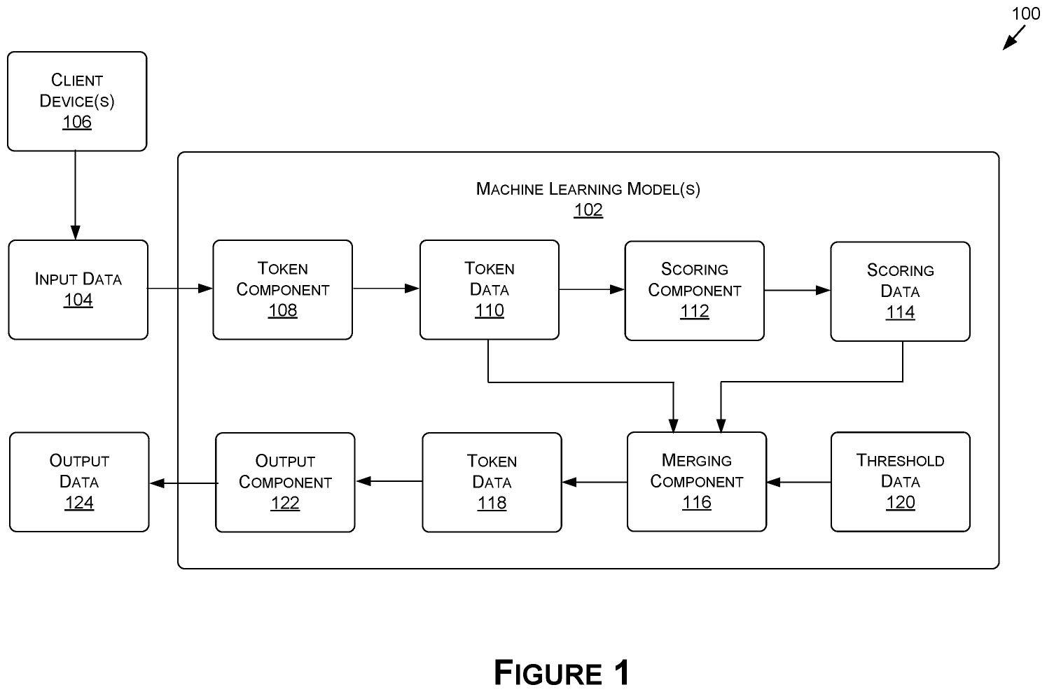

FIG. 1 is an example data flow diagram for a process 100 of using token merging to accelerate inference in a machine learning model(s), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more machine learning models 102 receiving input data 104 from one or more client devices 106. In some examples, the input data 104 may include audio data generated (e.g., using a microphone(s)) and/or sent by the client device(s) 106, where the audio data represent user speech from one or more users. Additionally, or alternatively, in some examples, the input data 104 may include text data generated (e.g., using a keyboard, touchscreen, and/or other input device) and/or sent by the client device(s) 106, where the text data represents one or more letters, words, numbers, characters, sub-words, phonemes, and/or symbols. While these are just a couple example types of data that the input data 104 may include, in other examples, the input data 104 may include any other type of data.

In some examples, the process 100 may include processing the input data 104 in order to generate text. For example, such as when the input data 104 includes audio data representing user speech, a processing component may include one or more speech-processing models, such as an automatic speech recognition (ASR) model(s), a speech to text (STT) model(s), a natural language processing (NLP) model(s), a diarization model(s), and/or the like, that is configured to generate the text associated with the user speech represented by the audio data. For instance, the text, which may also be represented by the input data 104, may represent a transcript (e.g., one or more letters, words, symbols, numbers, etc.) associated with the user speech. In such examples, the processing component may be included as part of the client device(s) 106 and/or included as part of the machine learning model(s) 102.

The process 100 may include the machine learning model(s) 102 using a token component 108 to process the input data 104 and generate token data 110. For example, the token component 108 may include one or more modules, one or more layers, and/or one or more other components of the machine learning model(s) 102 that are configured to process the letters, the words, the numbers, the symbols, and/or the like associated with the input data 104 (e.g., the user speech, the text, etc.). In some examples, the token component 108 may process the input data 104 using one or more processes, such as tokenization. Based at least on the processing, the token component 108 may be configured to generate tokens associated with the input data 104, where the token data 110 represents the tokens. As described herein, a token may represent a word, a part of a word, a symbol (e.g., punctuation), a number, and/or the like.

In some examples, the token component 108 may be configured to further process the input data 104 and/or the tokens, such as by transforming one or more of the tokens (e.g., each token) into a respective vector (which may also represented by the token data 110). As described herein, a vector may include a numerical representation associated with the word, the part of the word, the symbol, the number, and/or the like associated with a token.

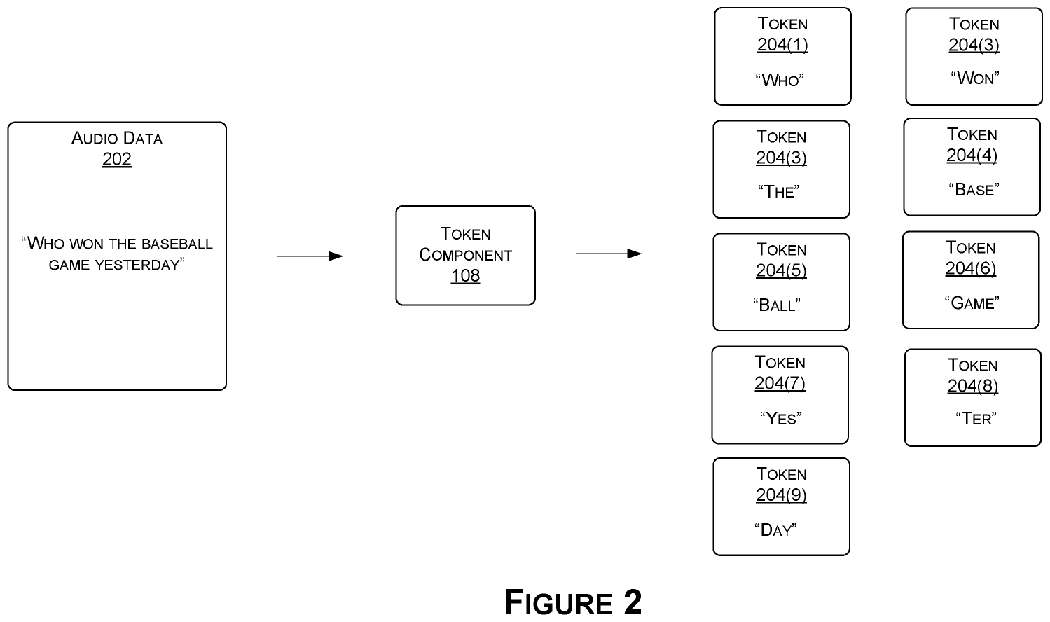

For instance, FIG. 2 illustrates an example of processing input data in order to generate tokens, in accordance with some embodiments of the present disclosure. As shown by the example of FIG. 2, the input data (which may represent, and/or include, the input data 104) includes audio data 202 representing user speech, where the user speech includes the text “Who won the baseball game yesterday?” The token component 108 may then generate a first token 204(1) that represents the word “who”, a second token 204(2) that represents the word “won”, a third token 204(3) that represents the word “the”, a fourth token 204(4) that represents a part of a word “base”, a fifth token 204(5) that represents a part of a word “ball”, a sixth token 204(6) that represents the word “game”, a seventh token 204(7) that represents a part of a word “yes”, an eighth token 204(8) that represents a part of a word “ter”, and a ninth token 204(9) that represents a part of a word “day”.

Referring back to the example of FIG. 1, the process 100 may include the machine learning model(s) 102 using a scoring component 112 that generates scores representing relationships between tokens, where the scores are represented by scoring data 114. The scoring component 112 may include one or more layers, one or more modules, and/or one or more other components of the machine learning model(s) 102. For instance, in some examples, the scoring component 112 may include an attention model that generates attention scores associated with the tokens. In such examples, the scoring component 112 may use one or more algorithms to compute the attention scores such as, but not limited to, a dot-product attention algorithm, a local attention algorithm, a convolution attention algorithm, a hierarchical attention algorithm, a structured attention algorithm, a multi-head attention algorithm, a cross-modal attention algorithm, and/or any other algorithm.

For a first example of determining an attention score, assume that a first token is mapped to a first vector A=[1,2,3] and a second token is mapped to a second vector B=[4,5,6]. The scoring component 112 may then apply a learned linear transformation to both the first vector A and the second vector B. For example, the scoring component may use a weight vector, such as W=[[0.5,0.2,0.1], [0.3,0.6,0.2], [0.2,0.4,0.8]], and a bias term b=[0.1,0.2,0.3]. As such, the scoring component 112 may determine a transformed vector A=W*A+b=[1.7,2.8,4.9] and a transformed vector B=W*B+b=[6.8,9.7,13.2]. The scoring component 112 may then compute a similarity score between the transformed vector A and the transformed vector B using a similarity metric, such as a dot product or cosine similarity. For instance, the dot product may determine the similarity score by multiplying the transformed vector A by the transformed vector B, which provides a similarity score of 118.36. The cosine similarity may determine the similarity score as cos_sim(transformed_A, transformed_B), which provides a similarity score of 0.9904.

In some examples, the scoring component 112 may determine the scores using relative position encoding. For example, the scoring component 112 may compute the scores based on the following equations:

$$Q = Query * W\_q \qquad ( 1 )$$

$$K = Key * W\_k \qquad ( 2 )$$

$$V = Value * W\_v \qquad ( 3 )$$

In equations (1)-(3), the Query, Key, and Value are input vectors and the W_q, W_k, and W_v are learned projection metrices. As such, the relative position encoding between the Query and Key vectors may be computed by the following equation:

$$RP = Relative\_Position * W\_rp \qquad ( 4 )$$

In equation (4), the Relative_Position is a matrix that encodes the relative positions between the Query and Key vectors, and W_rp is the learning projection matrix for relative position encoding. As such, the scoring component 112 may compute the attention logits or scores by taking the dot product between the Query and Key projections, augmented by the relative position encoding:

$$Logits = ( Q + RP ) \cdot K \hat{} T \qquad ( 5 )$$

In equation (5), Logits represent the attention scores for each position in the input sequence. As such, the scoring component 112 may apply softmax activation to obtain the attention weights by the following:

$$Attention\_Weights = softmax ( Logits ) \qquad ( 6 )$$

In equation (7), softmax normalizes the attention Logits across positions, producing attention weights that sum to 1. As such, the scoring component 112 may compute a weighted sum of the value vectors using the attention weights by the following:

$$Weighted\_Sum = Attention\_Weights \cdot V \qquad ( 7 )$$

Equation (7) combined the value vectors based on the attention weights, giving the final attended representation. As such, these equations (1)-(7) may illustrate the basic steps involved in computing attention scores with relative position encoding. For instance, the equations (1)-(7) capture the interactions between the Query and Key vectors, augmented by the relative positions, to determine the importance or relevance of each position in the input sequence during the attention process.

The process 100 may include the machine learning model(s) 102 using a merging component 116 that performs token merging using at least the scoring data 114 and/or the token data 110, where the tokens after token merging are represented by token data 118. For instance, the merging component 116 may include one or more layers, one or more modules, and/or one or more other components associated with the machine learning model(s) 102 that perform the token merging. In some examples, to perform token merging, the merging component 116 may determine to merge a token pair based on a score associated with the token pair satisfying (e.g., being equal to or greater than) a threshold score, where the threshold score is represented by threshold data 120. As described herein, the threshold score may include, but is not limited to, 0.5, 0.9. 0.99, 5, 50, 100, 75%, 85%, 90%, 95%, 99%, 99.9%, and/or any other number and/or percentage.

In some examples, the merging component 116 may limit the number of token pairs that are merged, such as at one or more iterations (e.g., each layer of token merging) associated with the text. For example, even if scores associated with multiple token pairs satisfy the threshold score, the merging component 116 may still limit the number of token pairs that are merged to a threshold number of pairs. In some examples, the threshold number of pairs may include a set threshold such as, but not limited to, one pair, two pairs, five pairs, ten pairs, and/or any other number of pairs. Additionally, or alternatively, in some examples, the threshold number of pairs may be dynamically determined based on one or more factors. For instance, the merging component 116 may determine the threshold number of pairs based on the size of the input (e.g., the number of words, the number of tokens, etc.), which iteration of the merging is being performed, and/or based on one or more additional and/or alternative factors. For example, the merging component 116 may increase the threshold number of pairs as the size of the input also increases.

In some examples, such as based on the 1D constraints associated with text, the merging component 116 may use one or more additional and/or alternative techniques for merging tokens. For example, such as to maintain the ordering of the input sequence associated with the text, the merging component 116 may only merge token pairs when tokens are located proximate to one another, which is described in more detail herein. Additionally, in some examples, such as to also maintain the ordering of the input sequence associated with the text, the merging component 116 may use one or more techniques to recover the token order. For example, since the merging component 116 may merge tokens that are located next to one another within the sequence, the merging component 116 may cause the newly generated tokens to remain in similar positions as the merged token pairs. As described herein, by maintaining the order associated with the tokens, the merging component 116 may also maintain the same semantic meaning as the original text.

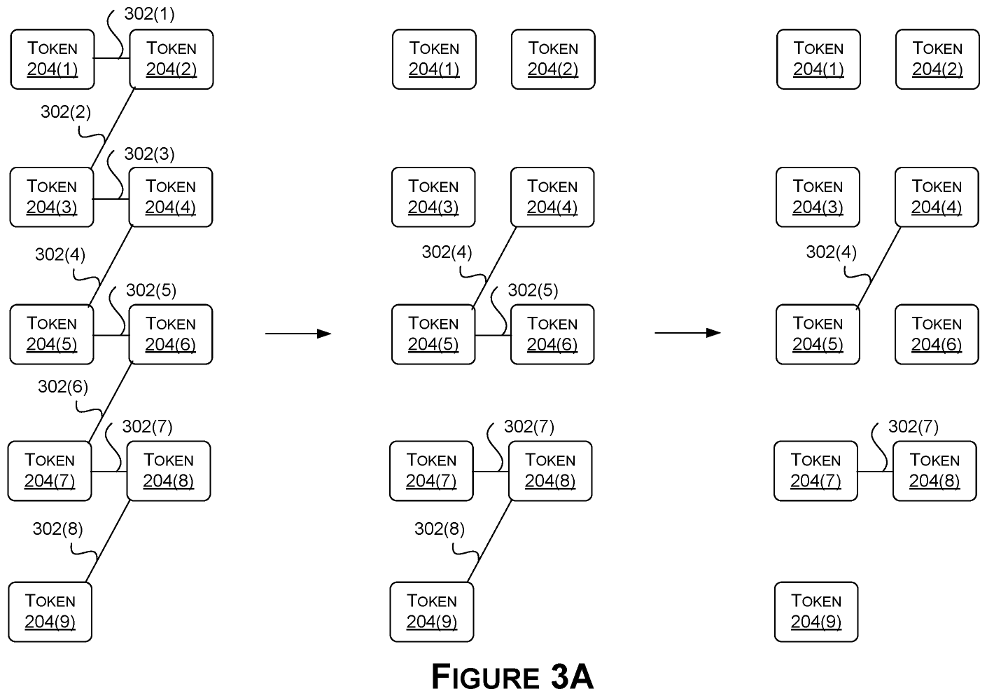

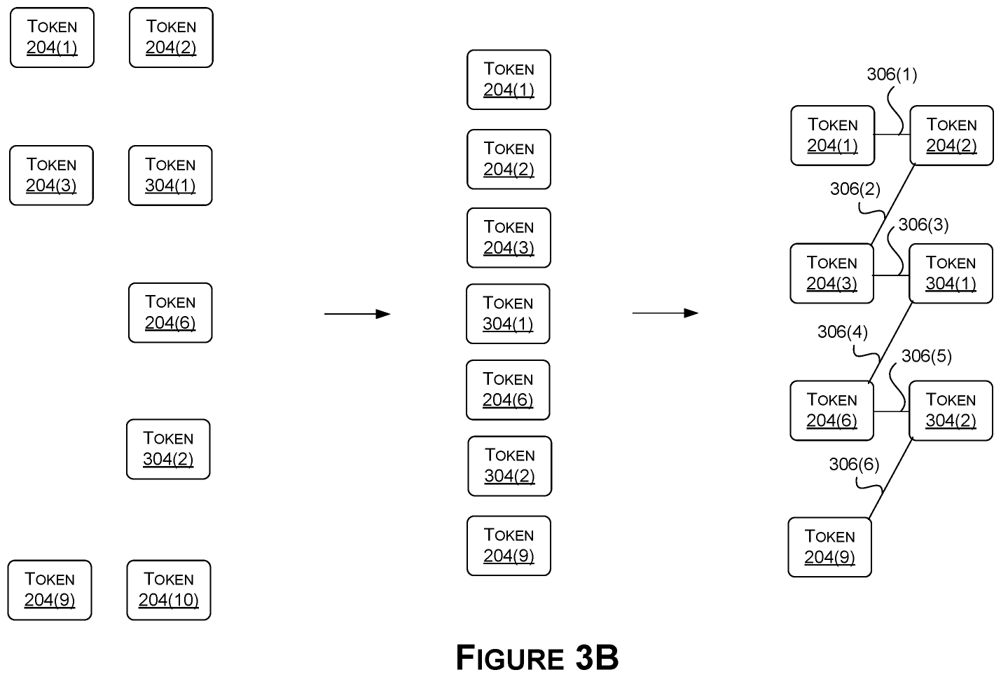

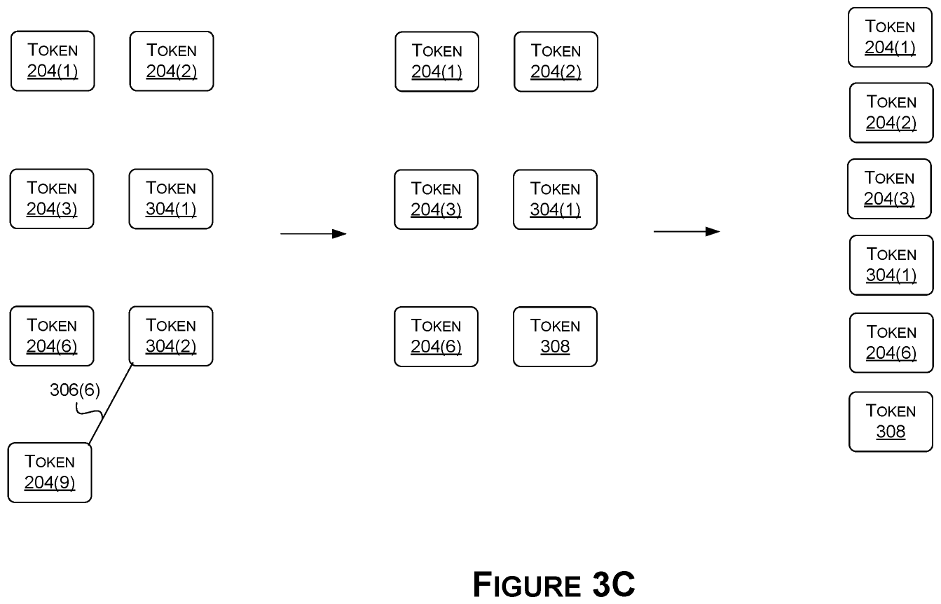

For instance, FIGS. 3A-3C illustrate an example of performing token merging associated with speech processing, in accordance with some embodiments of the present disclosure. As shown by the left illustration of FIG. 3A, the merging component 116 may initially assign the tokens 204(1)-(9) into two sets, such a left set that starts at the first token 204(1) and then includes every other token 204(3), 204(5), 204(7), and 204(9), and a right set that starts at the second token 204(2) and includes every other token 204(4), 204(6), and 204(8). The merging component 116 may then analyze token pairs that are located proximate to one another, where the token pairs are represented by 302(1)-(8). For example, the merging component 116 may analyze the scores associated with the token pairs 302(1)-(8) (e.g., where the scores may be represented by the scoring data 114).

Next, and as shown by the middle illustration of FIG. 3A, the merging component 116 may determine that the fourth token pair 302(4) between the fourth token 204(4) (e.g., base) and the fifth token 204(5) (e.g., ball) are related (e.g., the score satisfies the threshold score), the fifth token pair 302(5) between the fifth token 204(5) (e.g., ball) and the sixth token 204(6) (e.g., game) are related (e.g., the score satisfies the threshold score), the seventh token pair 302(7) between the seventh token 204(7) (e.g., yes) and the eighth token 204(8) (e.g., ter) are related (e.g., the score satisfies the threshold score), and the eighth token pair 302(8) between the eighth token 204(8) (e.g., ter) and the ninth token 204(9) (e.g., day) are related (e.g., the score satisfies the threshold score).

Next, and as shown by the right illustration of FIG. 3A, the merging component 116 may determine that a threshold number of pairs includes two pairs. In some examples, the merging component 116 may determine to use a set threshold number of pairs while, in other examples, the merging component 116 may dynamically determine the threshold number of pairs. The merging component 116 may then determine to merge the fourth token pair 302(4) that includes the fourth token 204(4) (e.g., base) and the fifth token 204(5) (e.g., ball) and the seventh token pair 302(7) that includes the seventh token 204(7) (e.g., yes) and the eighth token 204(8) (e.g., ter). In some examples, the merging component 116 makes the determination based on the scores associated with the fourth token pair 302(4) and the seventh token pair 302(7) including the highest scores (e.g., higher than the scores associated with the fifth token pair 302(5) and the eighth token pair 302(8)). In some examples, the merging component 116 makes the determination using one or more additional and/or alternative techniques.

Next, and as shown by the left illustration of FIG. 3B, the merging component 116 may merge the fourth token 204(4) with the fifth token 204(5) to generate a tenth token 304(1) (e.g., baseball) and merge the seventh token 204(7) with the eighth token 204(8) to generate an eleventh token 304(2) (e.g., yester). In some examples, the merging component 116 may use any technique to perform the token merging. For example, the merging component 116 may add the vectors associated with the tokens, average the vectors associated with the tokens, multiply the vectors associated with the tokens, and/or perform any other mathematical technique to merge the tokens.

Next, and as shown by the middle illustration of FIG. 3B, the merging component 116 may reorder the tokens 204(1)-(3), 304(1), 204(6), 304(2), and 204(9). As described herein, the merging component 116 may reorder the tokens 204(1)-(3), 304(1), 204(6), 304(2), and 204(9) using a technique that maintains the same semantic meaning of the original user speech. For instance, and as shown, the order includes the first token 204(1), followed by the second token 204(2), followed by the third token 204(3), followed by the tenth token 304(1), followed by the sixth token 204(6), followed by the eleventh token 304(2), and finally followed by the ninth token 204(9).

As described herein, in some examples, the machine learning model(s) 102 may include multiple layers such that token merging is performed during multiple iterations. For instance, and as shown by the right illustration of FIG. 3B, the merging component 116 may initially assign the tokens 204(1)-(3), 304(1), 204(6), 304(2), and 204(9) into two sets, such a left set that includes the tokens 204(1), 204(3), 204(6), and 204(9) and a right set that includes tokens 204(2), 304(1), and 304(2). The merging component 116 may then analyze token pairs that are located proximate to one another, where the token pairs are represented by 306(1)-(6). For example, the merging component 116 may analyze the scores associated with the token pairs 306(1)-(6) (e.g., where the scores may be represented by the scoring data 114), where the scoring component 112 may have determined the scores during the second iteration.

Next, and as shown by the left illustration of FIG. 3C, the merging component 116 may determine that the sixth token pair 306(6) between the eleventh token 304(2) (e.g., yester) and the ninth token 204(9) (e.g., day) are related (e.g., the score satisfies the threshold score). As such, and as illustrated by the middle illustration of FIG. 3C, the merging component 116 may then merge the eleventh token 304(2) with the ninth token 204(9) to generate a twelfth token 308 (e.g., yesterday). Additionally, and as illustrated by the right illustration of FIG. 3C, the merging component 116 may reorder the tokens 204(1)-(3), 304(1), 204(6), and 308. As described herein, the merging component 116 may reorder the tokens 204(1)-(3), 304(1), 204(6), and 308 using a technique that maintains the same semantic meaning of the original user speech. For instance, and as shown, the order includes the first token 204(1), followed by the second token 204(2), followed by the third token 204(3), followed by the tenth token 304(1), followed by the sixth token 204(6), and finally followed by the twelfth token 308.

Referring back to the example of FIG. 1, the process 100 may include the machine learning model(s) 102 using an output component 122 that processes the token data 118 and, based at least on the processing, generating output data 124. For instance, the output component 122 may represent one or more layers, one or more modules (e.g., a feed forward module, a convolution module, etc.), and/or one or more other components of the machine learning model(s) 102. For a first example, such as if the machine learning model(s) 102 is associated with speech recognition, the output component 122 may generate an output that includes text representing input speech. For a second example, such as if the machine learning model(s) 102 is associated with speech-to-text translation, the output component 122 may generate an output that includes text associated with a first language that differs from input speech associated with a second, different language. Still, for a third example, such as if the machine learning model(s) 102 is associated with a dialogue system, the output component 122 may generate an output that includes text representing a response to an input request. While these are just three example outputs associated with the machine learning model(s) 102, in other examples, the machine learning model(s) 102 may be trained to generate any type of output.

In some examples, one or more of the components 108, 112, 116, and 122 may be associated with a transformer and/or a backbone of the machine learning model(s) 102. However, in other examples, one or more of the components 108, 112, 116, and 122 may be associated with another portion of the machine learning model(s) 102.

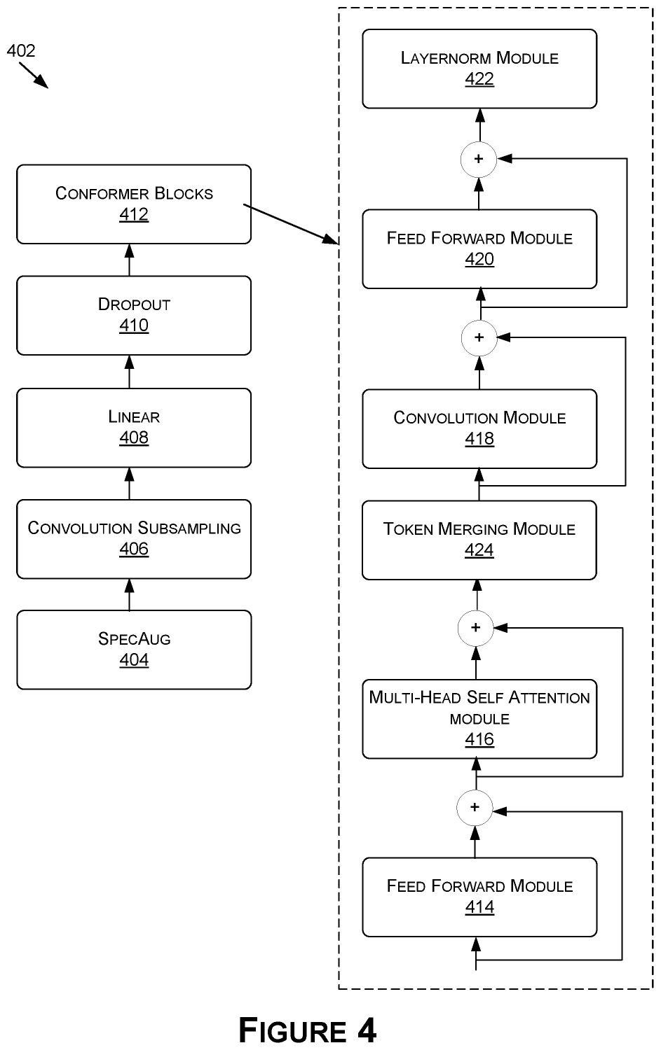

For instance, FIG. 4 illustrates an example of a Conformer architecture 402 that includes token merging, where the Conformer architecture 402 is associated with automatic speech recognition, in accordance with some embodiments of the present disclosure. As shown, the Conformer architecture 402 may include multiple components (e.g., modules, layers, etc.), such as a SpecAugmentation component 404, a convolution subsampling component 406, a linear component 408, a dropout component 410, and a conformer blocks component 412. Additionally, the conformer blocks component 412 may include multiple components (e.g., modules, layers, etc.), such as a feed forward module 414, multi-head self attention module 416, a convolution module 418, a feed forward module 420, and a layernorm module 422.

As further illustrated by the example of FIG. 4, in order to accelerate the inference associated with the Conformer architecture 402, a token merging component 424 may be added to the Conformer architecture 402. While the example of FIG. 1 illustrates the token merging module 424 as being located between the multi-head self attention module 416 and the convolution module 418, in other examples, the token merging component 424 may be located at one or more additional and/or alternative locations within the Conformer architecture 402. For example, the token merging module 424 may be located after the convolution module 418, after the feed forward module 420, and/or the like.

In some examples, for an input xᵢ that is applied to the Conformer architecture 402, the output yᵢ may include:

$${\tilde{x}}_{i} = {x}_{i} + 0.5 \times FFN ( {x}_{i} ) \qquad ( 8 )$$

$${x}_{i}^{′} = {\tilde{x}}_{i} + MHSA ( {\tilde{x}}_{i} ) \qquad ( 9 )$$

$${x}_{i}^{′} = ToMe ( {x}_{i}^{′} ) \qquad ( 10 )$$

$${x}_{i}^{″} = {x}_{i}^{′} + Conv ( {x}_{i}^{′} ) \qquad ( 11 )$$

$${y}_{i} = LayerNorm ( {x}_{i}^{″} + 0.5 \times FFN ( {x}_{i}^{″} ) ) \qquad ( 12 )$$

As shown, equation (8) may relate to the feed forward module 414, equation (9) may relate to the multi-head module 416, equation (10) may relate to the token merging module 424, equation (11) may relate to the convolution module 418, and equation (12) may relate to the feed forward module 420.

In some examples, one or more of the modules 414, 416, 418, 420, 422, and 424 from the example of FIG. 4 may correspond to one or more of the components 108, 112, 116, and 122 from the example of FIG. 1. For example, the multi-head self attention module 416 may correspond to the scoring component 112, the token merging module 424 may correspond to the merging component 116, and the convolution module 418, the feed forward module 420, and/or the layernorm module 422 may correspond to the output component 122. Additionally, while the example of FIG. 4 may illustrate one layer that includes the modules 414, 416, 418, 420, 422, and 424, in other examples, the conformer blocks component 412 may include any number of layers that each include the modules 414, 416, 418, 420, 422, and 424.

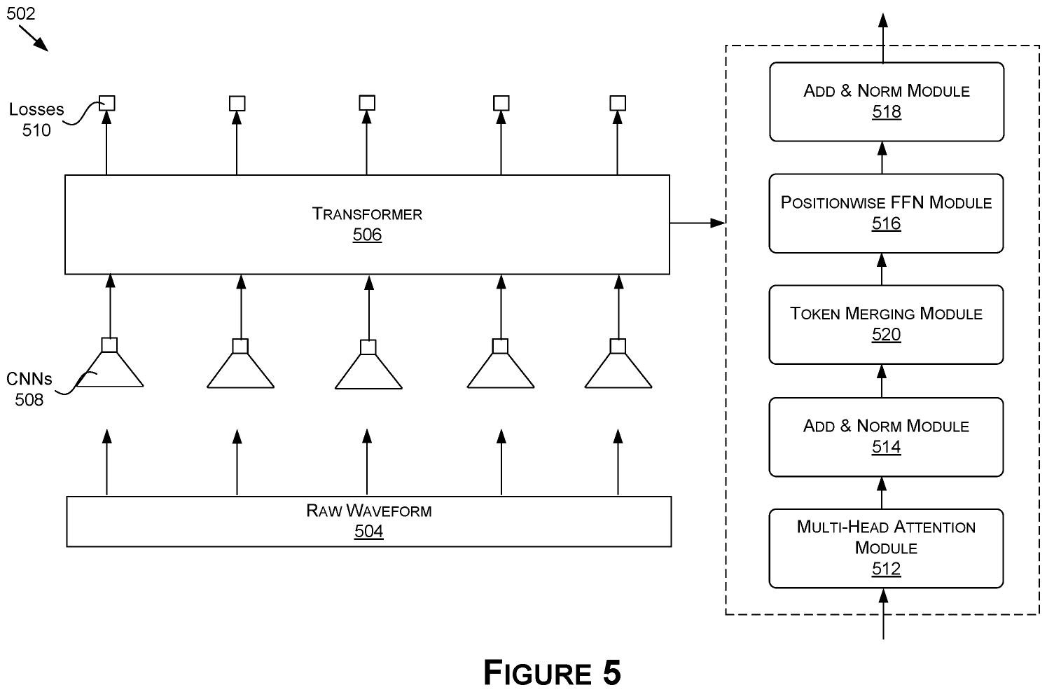

FIG. 5 illustrates an example of a speech recognition model 502 (e.g., wav2vec) that includes token merging, in accordance with some embodiments of the present disclosure. As shown, the speech recognition module 502, which may take as input a raw waveform 502 (which may be represented by the input data 104), may include at least a transformer 506, one or more convolution neural networks 506 (although only one is labeled for clarity reasons), and one or more contrastive losses 510 (which only one is again labeled for clarity reasons). The transformer 506, which may take as input positional encodings and embeddings, may include at least a multi-head attention module 512, a add and norm module 512, a positionwise FFN module 516, and another add and norm module 518. Additionally, such as to accelerate inference of the speech recognition model 502, the transformer 506 may include a token merging module 520.

In some examples, one or more of the modules 512, 514, 516, 518, and 520 from the example of FIG. 5 may correspond to one or more of the components 108, 112, 116, and 122 from the example of FIG. 1. For example, the multi-head attention module 512 may correspond to the scoring component 112, the token merging module 520 may correspond to the merging component 116, and the positionwise FFN module 516 may correspond to the output component 122. Additionally, while the example of FIG. 5 illustrates the token merging component 520 as being after the add and norm module 514, in other examples, the token merging component 520 may be located at a different position within the transformer 506. For example, the token merging module 520 may be after the multi-head attention module 512, after the positionwise FFN module 516, and/or after the add and norm module 518.

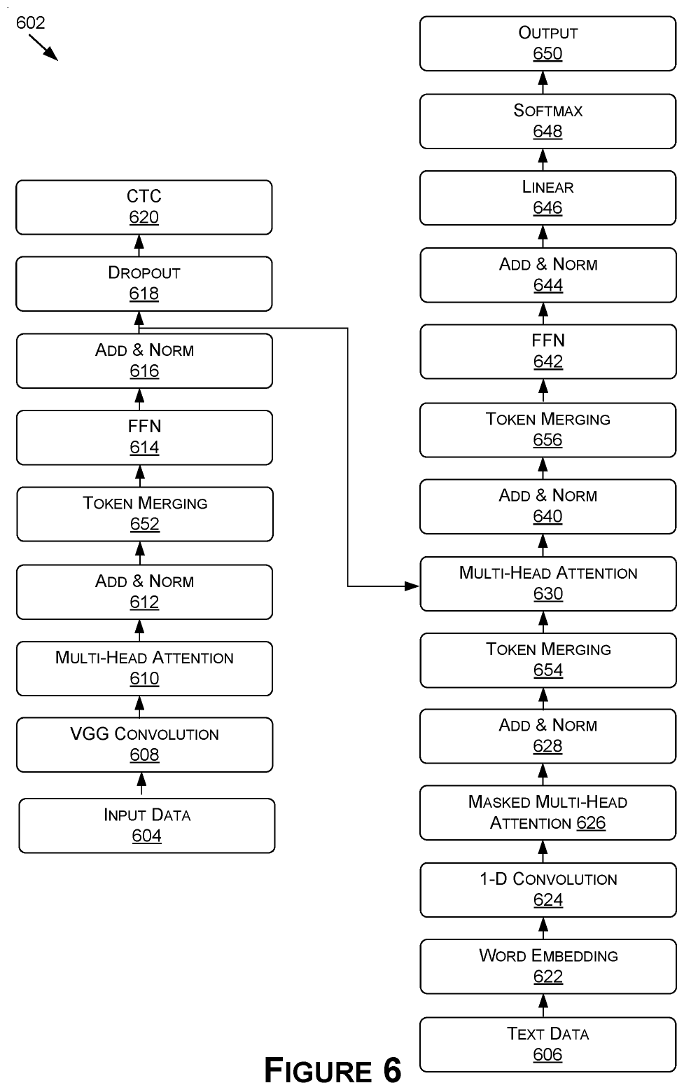

FIG. 6 illustrates an example of a machine learning model 602 that is associated with translating speech from a first language to a second language, in accordance with some embodiments of the present disclosure. As shown, the machine learning model 602 may include two portions, where a first portion is associated with at least processing input data 604 (which may represent, and/or include, the input data 104) representing user speech in a first language and a second portion is associated with processing text data 606 representing text in a second, target language. For instance, the first component may include at least a visual geometry group convolution component 608, a multi-head attention component 610, an add and norm component 612, a feed forward network (FFN) 614, another add and norm component 616, and a dropout component 618. As further shown, an output from the first portion includes a connectionist temporal classification (CTC) 620.

The second portion may include a word embedding component 622, a 1-D convolution component 624, a masked multi-head attention component 626, an add and norm component 628, a multi-head attention component 630, another add and norm component 640, a feed forward network (FFN) 642, another add and norm component 644, a linear component 646, and a softmax component 648. As further shown, the second portion may generate an output 650, which may include text associated with the user speech, but in the target language.

As further illustrated in the example of FIG. 6, the first portion of the machine learning model 602 may include a first token merging component 652 and the second portion of the machine learning model 602 may include a second token merging component 654 and a third token merging component 656. As described herein, the machine learning model 602 may include the first token merging component 652, the second token merging component 654, and/or the third token merging component 656 in order to accelerate inference associated with the machine learning model 602. While the example of FIG. 6 illustrates the first token merging component 652 after the add and norm component 612, the second token merging component 654 after the add and norm component 628, and the third token merging component 656 after the add and norm component 640, in other examples, the first token merging component 652, the second token merging component 654, and/or the third token merging component 656 may be located at any other locations within the machine learning model 602.

In some examples, one or more equations may be used to compute the scores that are used by the first token merging component 652, the second token merging component 654, and/or the third token merging component 656 when performing token merging. For example, equations (1)-(7) may be used to compute the scores that the first token merging component 652 and the second token merging component 654 use for token merging since only tokens associated with a single language are processed by the first token merging component 652 and the second token merging component 654. For instance, the tokens associated with the first language may be processed by the first token merging component 652 while tokens associated with the target language may be processed by the second token merging component 654. However, since the third token merging component 656 may be processing tokens associated with both languages, different equations may be used to compute the scores.

For example, when computing cross-attention scores between speech sequences and textual sequences, Query, Key, and Value projections may be computed by the following:

$${Q}_{- speech} = Speech * W\_q \_speech \qquad ( 13 )$$

$${K}_{- speech} = Speech * W\_k \_speech \qquad ( 14 )$$

$${V}_{- speech} = Speech * W\_v \_speech \qquad ( 15 )$$

In equations (13)-(15), speech represents the input speech sequences and W_q_speech, W_k_speech, and W_v_speech represent the learnable projection metrices specific to the speech sequences. As such, the projections for the textual sequences may be computed as the following:

$${Q}_{\_ text} = Text * W\_q \_text \qquad ( 16 )$$

$${K}_{- text} = Text * W\_k \_text \qquad ( 17 )$$

$${V}_{- text} = Text * W\_v \_text \qquad ( 18 )$$

In equations (16)-(18), text represents the input textual sequences and W_q_text, W_k_text, and W_v_text represent the learnable projection metrices specific to the textual sequences. The attention logits or scores between the speech and textual sequences may be computed by taking the dot product between the query vectors of speech and textual sequences by:

$$Logits = Q\_text \cdot K\_speech \hat{} T \qquad ( 19 )$$

In equation (19), Logits represents the attention scores indicating the relevance or similarity between each position in the speech sequences and the textual sequences. As such, a softmax activation may be applied to obtain the attention weights by the following:

$$Attention\_Weights = softmax ( Logits ) \qquad ( 20 )$$

In equation (20), softmax normalizes the attention Logits across positions, producing attention weights that sum to 1. As such, the weighted sum of the Value vectors of the textual sequences may be computed using the attention weights by the following:

$$Weighted\_Sum \_text = Attention\_Weights \cdot V\_text \qquad ( 21 )$$

Equation (21) may combine the Value vectors of the textual sequences based on the attention weights, yielding the final attended representation of the textual sequences. Similarly, the weighted sum of the Value vectors of the speech sequences may be computed using the attention weights by the following:

$$Weighted\_Sum \_speech = Attention\_Weights \hat{} T \cdot V\_speech \qquad ( 22 )$$

In equation (22), the transpose of the Attention_Weights is used to align with the dimensions of the speech sequences. As such, the Weighted_Sum_text and the Weighted_Sum_speech may represent the attended representations of the textual and speech sequences, respectively, obtained through cross-attention. As such, equations (13)-(22) may captured the cross-modal interactions and dependencies between speech and textual sequences, enabling the machine learning model 602 to focus on relevant information from each modality.

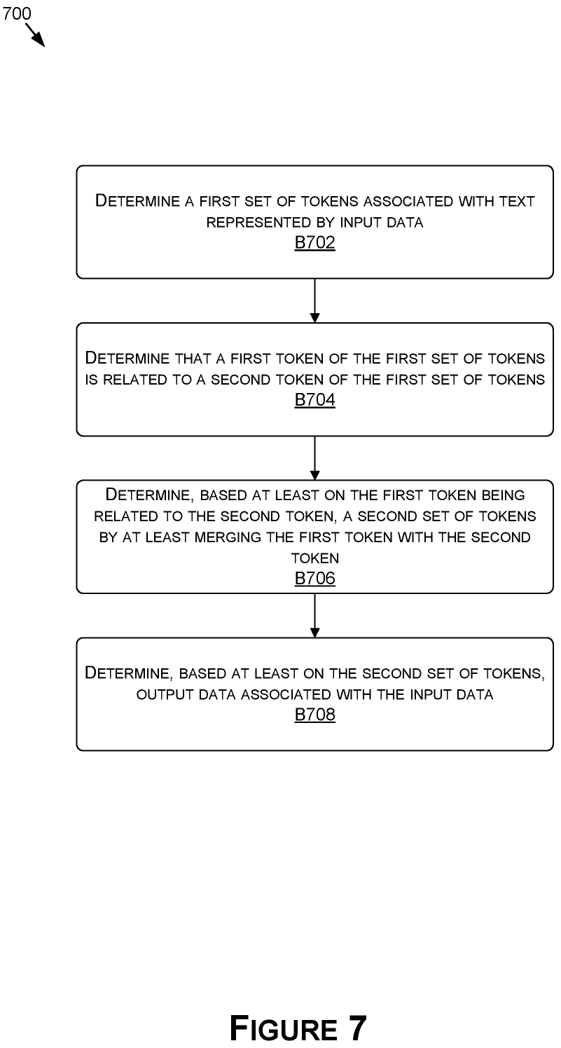

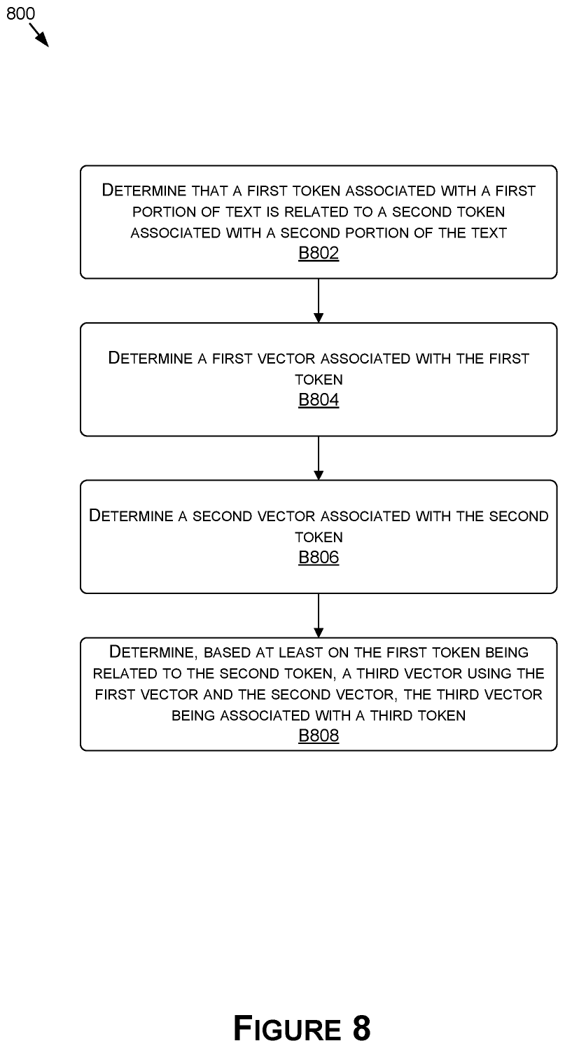

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods 700 and 800 may also be embodied as computer-usable instructions stored on computer storage media. The methods 700 and 800 may be provided by a standalone application, a service or hosted service (standalone or in combination with another hosted service), or a plug-in to another product, to name a few. In addition, the methods 700 and 800 are described, by way of example, with respect to FIG. 1. However, the methods 700 and 800 may additionally or alternatively be executed by any one system, or any combination of systems, including, but not limited to, those described herein.

FIG. 7 is a flow diagram showing a method 700 for performing token merging when processing text, in accordance with some embodiments of the present disclosure. The method 700, at block B702, may include determining a first set of tokens associated with text represented by input data. For instance, the machine learning model(s) 102 (e.g., the token component 108) may process the input data 104 representing the text. As described herein, the input data 104 may include text data, audio data, and/or any other type of data. Based at least on processing the input data 104, the machine learning model(s) 102 may generate the first set of tokens associated with the text, where the first set of tokens may be represented by the token data 110. As described herein, a token may represent a word, a part of a word, a symbol (e.g., punctuation), a number, and/or the like associated with the text.

The method 700, at block B704, may include determining that a first token from the first set of tokens is related to a second token from the first set of tokens. For instance, the machine learning model(s) 102 (e.g., the scoring component 112) may determine a score, such as an attention score, indicating a relationship between the first token and the second token. The machine learning model(s) 102 (e.g., the merging component 116) may then determine, using the score, that the first token is related to the second token. For example, the machine learning model(s) 102 may make the determination based on the score satisfying (e.g., being equal to or greater than) a threshold score.

The method 700, at block B706, may include determining, based at least on the first token being related to the second token, a second set of tokens by at least merging the first token with the second token. For instance, the machine learning model(s) 102 (e.g., the merging component 116) may generate a new token by merging the first token with the second token based at least on the relationship. The machine learning model(s) 102 may then generate the second set of tokens, which may be represented by the token data 118, using the merged token. For example, the machine learning model(s) 102 may replace the first token and the second token within the first set of tokens with the merged token based on the order of the tokens. In some examples, the machine learning model(s) 102 may perform similar processes to merge one or more additional pairs of tokens.

The method 700, at block B708, may include determining, based at least on the second set of tokens, output data associated with the input data. For instance, the machine learning model(s) 102 (e.g., the output component 122) may process the second set of tokens in order to generate the output data 124. For a first example, such as if the machine learning model(s) 102 is associated with speech recognition, the machine learning model(s) 102 may generate an output that includes text representing input speech. For a second example, such as if the machine learning model(s) 102 is associated with speech-to-text translation, the machine learning model(s) 102 may generate an output that includes text associated with a first language that differs from input speech associated with a second, different language. Still, for a third example, such as if the machine learning model(s) 102 is associated with a dialogue system, the machine learning model(s) 102 may generate an output that includes text representing a response to an input request.

FIG. 8 is a flow diagram showing a method 800 for merging tokens associated with text, in accordance with some embodiments of the present disclosure. The method 800, at block B802, may include determining that a first token associated with a first portion of text is related to a second token associated with a second portion of the text. For instance, the machine learning model(s) 102 (e.g., the scoring component 112) may determine a score, such as an attention score, indicating a relationship between the first token associated with the first portion of the text and the second token associated with the second portion of the text. The machine learning model(s) 102 (e.g., the merging component 116) may then determine, using the score, that the first token is related to the second token. For example, the machine learning model(s) 102 may make the determination based on the score satisfying (e.g., being equal to or greater than) a threshold score.

The method 800, at block B804, may include determining a first vector associated with the first token and the method 800, at block B806, may include determining a second vector associated with the second token. For instance, the machine learning model(s) 102 (e.g., the merging component 116) may map the first token to the first vector and map the second token to the second vector. As described herein, the first vector may include a numerical representation associated with the first portion of the text and the second vector may include a numerical representation associated with the second portion of the text.

The method 800, at block B806, may include determining, based at least on the first token being related to the second token, a third vector using the first vector and the second vector, the third vector being associated with a third token. For instance, the machine learning model(s) 102 (e.g., the merging component 116) may merge the first token with the second token by using the first vector and the second vector to generate the third vector. For example, the merging component 116 may add the vectors, average the vectors, multiply the vectors, and/or perform any other mathematical technique associated with the vectors. As such, the third vector may be associated with the third token that represents the merged token of the first token and the second token.

### Example Computing Device

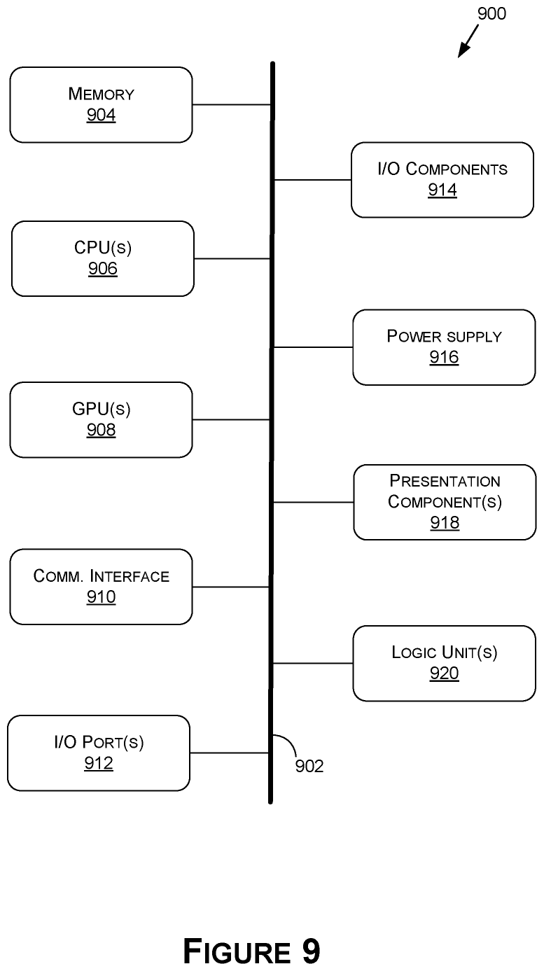

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

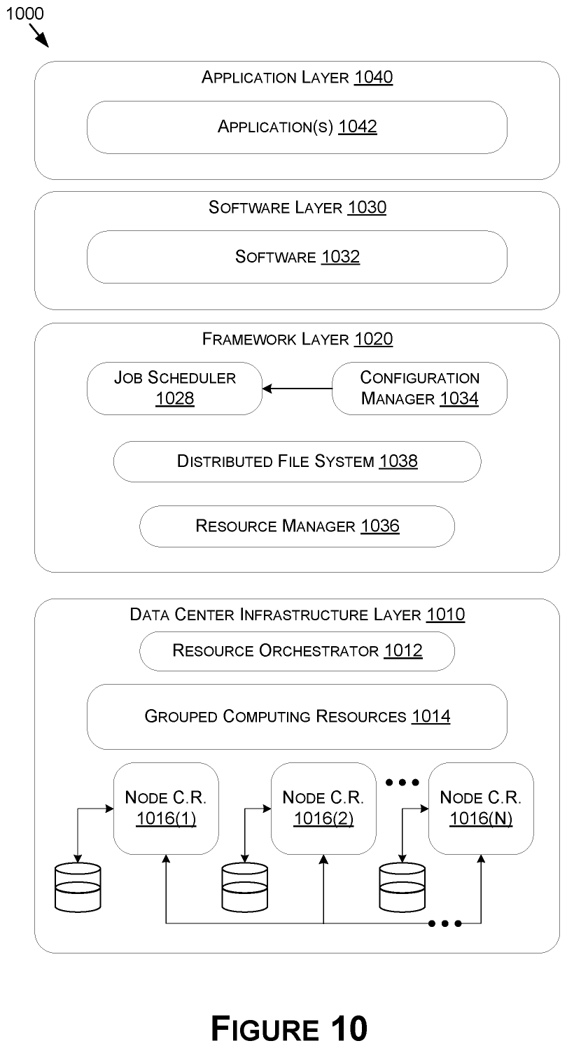

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining a first set of tokens associated with text corresponding to input data;
determining that a first token of the first set of tokens is related to a second token of the first set of tokens;
determining, based at least on the first token being related to the second token, a second set of tokens by at least merging the first token with the second token to generate a third token; and
determining, based at least on the second set of tokens, output data associated with the input data.

2. The method of claim 1, wherein the determining that the first token is related to the second token comprises:
determining a score associated with a relationship between the first token and the second token, and
determining that the score is equal to or greater than a threshold score.

3. The method of claim 1, further comprising:
determining that a fourth token of the first set of tokens is related to a fifth token of the first set of tokens; and
determining, based at least on a threshold number, to refrain from merging the fourth token with the fifth token.

4. The method of claim 3, further comprising:
determining a first score associated with a first relationship between the first token and the second token;
determining a second score associated with a second relationship between the fourth token and the fifth token; and
determining that the first score is greater than the second score,
wherein the determining refrain from merging the fourth token with the fifth token is further based at least on the first score being greater than the second score.

5. The method of claim 1, wherein:
the first set of tokens includes at least the first token, the second token, and a fourth token; and
the second set of tokens includes at least the fourth token and the third token.

6. The method of claim 5, wherein:
the fourth token is one of before the first token or after the second token within the first set of tokens; and
the fourth token is the one of before the third token or after the third token within the second set of tokens.

7. The method of claim 1, wherein the merging the first token with the second token comprises:
determining a first vector associated with the first token;
determining a second vector associated with the second token; and
determining, based at least on the first vector and the second vector, a third vector associated with the third token.

8. The method of claim 1, wherein the first set of tokens includes at least the first token, followed by the second token, and followed by a fourth token, and wherein the method further comprising:
determining, based at least on the first token being followed by the second token, whether the first token is related to the second token; and
determining, based at least on the second token being followed by the fourth token, whether the second token is related to the fourth token.

9. The method of claim 1, further comprising:
determining that the third token of the second set of tokens is related to a fourth token of the second set of tokens; and
determining, based at least on the third token being related to the fourth token, a third set of tokens by at least merging the third token with the fourth token to generate a fifth token,
wherein determining the output data associated with the input data is based at least on the third set of tokens.

10. A system comprising:
one or more processing units to:
determine, using one or more machine learning models, that a first token of a first set of tokens is related to a second token of the first set of tokens, the first set of tokens being associated with text corresponding to input data;
determine, using the one or more machine learning models and based at least on the first token being related to the second token, a second set of tokens by at least merging the first token with the second token to generate a third token; and
determine, based at least on the second set of tokens, output data associated with the input data.

11. The system of claim 10, wherein the determination that the first token is related to the second token comprises:
determining, using the one or more machine learning models, a score associated with a relationship between the first token and the second token, and
determining, using the one or more machine learning models, that the score is equal to or greater than a threshold score.

12. The system of claim 10, wherein the one or more processing units are further to:
determine, using the one or more machine learning models, that a fourth token of the first set of tokens is related to a fifth token of the first set of tokens; and
determine, using the one or more machine learning models and based at least on a threshold number, to refrain from merging the fourth token with the fifth token.

13. The system of claim 12, wherein the one or more processing units are further to:
determine, using the one or more machine learning models, a first score associated with a first relationship between the first token and the second token;
determine, using the one or more machine learning models, a second score associated with a second relationship between the fourth token and the fifth token; and
determine, using the one or more machine learning models, that the first score is greater than the second score,
wherein the determination to refrain from merging the fourth token with the fifth token is further based at least on the first score being greater than the second score.

14. The system of claim 10, wherein:
the first set of tokens includes a fourth token that is one of before the first token or after the second token; and
the second set of tokens includes the fourth token that is the one of before the third token or after the third token.

15. The system of claim 10, wherein the merging the first token and the second token comprises:
determining a first vector associated with the first token;
determining a second vector associated with the second token; and
determining, based at least on the first vector and the second vector, a third vector associated with the third token.

16. The system, of claim 10, wherein the one or more processing units are further to:
determine, using the one or more machine learning models, that the third token of the second set of tokens is related to a fourth token of the second set of tokens; and
determine, using the one or more machine learning models and based at least on the third token being related to the fourth token, a third set of tokens by at least merging the third token with the fourth token,
wherein the determination of the output data associated with the input data is based at least on the third set of tokens.

17. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implementing one or more large language models (LLMs);
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to generate, using one or more machine learning models, an output based at least on a first set of tokens associated with text corresponding to input data, wherein the first set of tokens is generated based at least on merging a first token of a second set of tokens with a second token of the second set of tokens, the first token representing at least a first portion of the text and the second token representing at least a second portion of the text.

19. The processor of claim 18, wherein the one or more processing units are further to:
determine a first score associated with a relationship between the first token and the second token; and
determine that the score is equal to or greater than a threshold score,
wherein the merging of the first token with the second token is based at least on the score being equal to or greater than the threshold score.

20. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implementing one or more large language models (LLMs);
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
